(19) United States
(12) Patent Application Publication
(10) Pub. No.: US 2023/0299381 A1
(43) Pub. Date: Sep. 21, 2023

(54) BATTERY COVER AND BATTERY COVER ASSEMBLY

(71) Applicant: HONDA MOTOR CO., LTD., Tokyo (JP)

(72) Inventors: Motoo Tsukada, Tokyo (JP); Yasunari Miyauchi, Tokyo (JP); Masakazu Hira, Tokyo (JP); Naohisa Kawahara, Tokyo (JP); Shugo Shimizu, Nagoya-shi (JP)

(73) Assignee: HONDA MOTOR CO., LTD., Tokyo (JP)

(21) Appl. No.: 18/113,404

(22) Filed: Feb. 23, 2023

(30) Foreign Application Priority Data
Mar. 18, 2022 (JP) 2022-044175

(51) Int. Cl. H01M 10/653; H01M 10/6561; H01M 50/202

(52) U.S. Cl. CPC H01M 10/653; H01M 10/6561; H01M 50/202; H01M 2220/20

(57) ABSTRACT

There is provided with a battery cover that can efficiently protect a battery from the ambient temperature environment. The battery cover comprises: a cover member that has a heat insulating property and encloses a battery mounted on a vehicle; an inlet formed in the cover member to introduce outside air into the cover member of the vehicle; and an outlet formed in the cover member to discharge the outside air introduced into the cover member from the inlet, the cover member includes a ventilation portion that connects the inlet and the outlet, and the ventilation portion is defined by a thin portion of the cover member and a thick portion of the cover member formed thicker than the thin portion.

### CROSS-REFERENCE TO RELATED APPLICATION(S)

This application claims priority to and the benefit of Japanese Patent Application No. 2022-044175 filed on Mar. 18, 2022, the entire disclosure of which is incorporated herein by reference.

### BACKGROUND OF THE INVENTION

### Field of the Invention

The present invention relates to a battery cover and a battery cover assembly.

### Description of the Related Art

In recent years, research and development on secondary batteries that contribute to increased energy efficiency has been conducted in order to enable more people to have access to affordable, reliable, sustainable, and advanced energy. Such a secondary battery (battery) is mounted in a vehicle such as an automobile. In particular, if a battery is installed in an engine room, the battery may be placed in an extremely severe temperature environment because the temperature greatly changes due to a temperature increase caused by the engine or under the influence of seasonal environments. Batteries placed in such temperature environments may be thermally degraded and their performance may become unstable, resulting in reduced service life.

Therefore, in order to protect the battery from the ambient temperature environment, battery covers, housing boxes, or the like have been developed. Japanese Patent No. 5057037 discloses that an air duct that guides traveling wind to the battery is provided to cool the battery stored in the housing box by the traveling wind.

However, in order to efficiently protect the battery from the ambient temperature environment, there is room for improvement in cooling and thermal insulation of the battery.

### Description of the Related Art

### SUMMARY OF THE INVENTION

An embodiment of the present invention provides a battery cover that can efficiently protect a battery from the ambient temperature environment. Further, an embodiment of the present invention contributes to increased energy efficiency.

According to one embodiment of the present invention, a battery cover comprises: a cover member that has a heat insulating property and encloses a battery mounted on a vehicle; an inlet formed in the cover member to introduce outside air into the cover member of the vehicle; and an outlet formed in the cover member to discharge the outside air introduced into the cover member from the inlet, wherein the cover member includes a ventilation portion that connects the inlet and the outlet, and the ventilation portion is defined by a thin portion of the cover member and a thick portion of the cover member formed thicker than the thin portion.

### BRIEF DESCRIPTION OF THE DRAWINGS

FIG. 1 is a schematic view of an engine room of a vehicle in which a battery is installed;

FIG. 2 is a schematic view of a battery cover according to an embodiment;

FIG. 3 is a cross-sectional view of the battery cover according to the embodiment taken along line A-A′;

FIG. 4 is a cross-sectional view of the battery cover according to the embodiment taken along line B-B′;

FIG. 5 is a cross-sectional view of the battery cover according to the embodiment taken along line C-C′;

FIG. 6 is a cross-sectional view of the battery cover according to the embodiment, which illustrates a flow of outside air;

FIG. 7 is a cross-sectional view of the battery cover according to the embodiment taken along line C-C′ passing through a ventilation portion;

FIG. 8 is a cross-sectional view of a battery cover according to another embodiment passing through a ventilation portion;

FIG. 9 is a cross-sectional view of a battery cover according to still another embodiment passing through a ventilation portion;

FIG. 10 is a cross-sectional view of a battery cover according to still another embodiment, which illustrates a flow of outside air;

FIG. 11 is a cross-sectional view of a battery cover according to still another embodiment, which illustrates a flow of outside air;

FIG. 12 is a cross-sectional view of a battery cover according to still another embodiment, which illustrates a flow of outside air;

FIG. 13 is a schematic view of a battery cover assembly according to an embodiment;

FIG. 14 is a cross-sectional view of the battery cover of the battery cover assembly according to the embodiment taken along line A1-A1′;

FIG. 15 is a schematic diagram of a battery arrangement part according to the embodiment;

FIG. 16 is a schematic view of the battery cover of the battery cover assembly according to the embodiment;

FIG. 17 is a schematic view of a battery cover assembly according to another embodiment; and

FIG. 18 is a cross-sectional view of the battery cover of the battery cover assembly according to another embodiment taken along line A2-A2′.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Battery Cover According to Embodiment

A battery cover according to an embodiment includes a cover member that has a heat insulating property and encloses a battery mounted in a vehicle, an inlet that is formed in the cover member to introduce outside air into the cover member of the vehicle, and an outlet that is formed in the cover member to discharge the outside air introduced from the inlet into the cover member. Furthermore, the cover member has a ventilation portion that communicates between the inlet and the outlet. The ventilation portion is defined by the thin portion of the cover member and the thick portion of the cover member formed thicker than the thin portion, so that the battery can be efficiently protected from the surrounding temperature environment.

### Battery

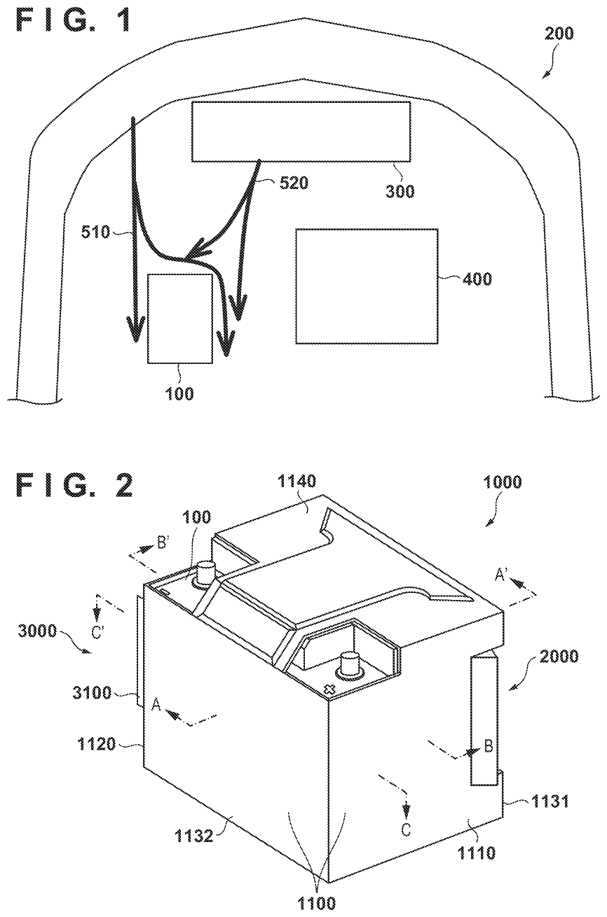

FIG. 1 is a schematic view of an engine room of a vehicle in which a battery is installed. The traveling direction (vehicle length direction) of the vehicle, the lateral direction (vehicle width direction) orthogonal thereto, and the up-and-down direction orthogonal to the traveling direction and the lateral direction will also be referred to as front-and-rear direction, right-and-left direction, and up-and-down direction, respectively.

FIG. 1 is a view of the engine room according to an embodiment as viewed from above a vehicle 200, and illustrates only main devices that affect the temperature of the battery. In the engine room according to the embodiment, a cooling device 300 including a radiator, a condenser, and a fan is arranged on the front side in the front-and-rear direction of the vehicle 200. An engine 400 is arranged on the rear side of the cooling device 300, and a battery 100 is arranged on the left side of the engine 400. The battery 100 is cooled by outside air 510 such as traveling wind or natural wind from the front side toward the rear side of the vehicle. On the other hand, the battery 100 is heated by hot air 520 from the cooling device 300 and the engine 400. The battery 100 is not particularly limited, and may be a driving battery or an auxiliary battery.

### Battery Cover

FIG. 2 is a schematic view of a battery cover according to the embodiment. A battery cover 1000 includes a cover member 1100 that surrounds the battery 100, and the cover member 1100 has a heat insulating property. The cover member 1100 includes a front wall portion 1110 located on the front side of the vehicle 200, a rear wall portion 1120 located on the rear side of the vehicle 200, left and right side wall portions 1131 and 1132 located between the front wall portion 1110 and the rear wall portion 1120 in the front-and-rear direction, and includes an upper wall portion 1140 located on the upper side of the vehicle 200 in the up-and-down direction.

The battery cover 1000 includes an inlet 2000 that is formed in the cover member 1100 to introduce the outside air 510 into the cover member 1100, and includes an outlet 3000 that is formed in the cover member 1100 to discharge the outside air 510 having been introduced into the cover member 1100 from the inlet 2000.

In the embodiment, the inlet 2000 is provided in the front wall portion 1110 including the corners connecting the front wall portion 1110 and the side wall portions 1131. However, the location of the inlet 2000 is not particularly limited as long as the inlet 2000 is provided at a location where the outside air 510 is introduced into the cover member 1100 when the battery cover 1000 is arranged in the engine room. For example, the inlet 2000 can be provided on the front wall portion 1110 or the side wall portions 1131 and 1132 on the sides closer to the front wall portion 1110 seen along the front-and-rear direction. The inlet 2000 is formed in the front wall portion 1110 so as to be a substantially rectangular opening that is long in the up-and-down direction, but the shape and dimension of the inlet 2000 are not particularly limited as long as the inlet 2000 can efficiently introduce the outside air 510 into the cover member 1100.

In the embodiment, the outlet 3000 is provided in the rear wall portion 1120 including the corners connecting the rear wall portion 1120 and the side wall portion 1132. However, the location of the outlet 3000 is not particularly limited as long as the outlet 3000 is provided at a location from which the outside air 510 having been introduced into the cover member 1100 is discharged. For example, the outlet 3000 can be provided on the rear wall portion 1120 or the side wall portions 1131 and 1132 on the sides closer to the rear wall portion 1120 seen along the front-and-rear direction. The outlet 3000 is formed in the rear wall portion 1120 so as to be a substantially rectangular opening that is long in the up-and-down direction, but the shape and dimension of the outlet 3000 are not particularly limited as long as the outlet 3000 can efficiently discharge the outside air 510.

### Cover Member

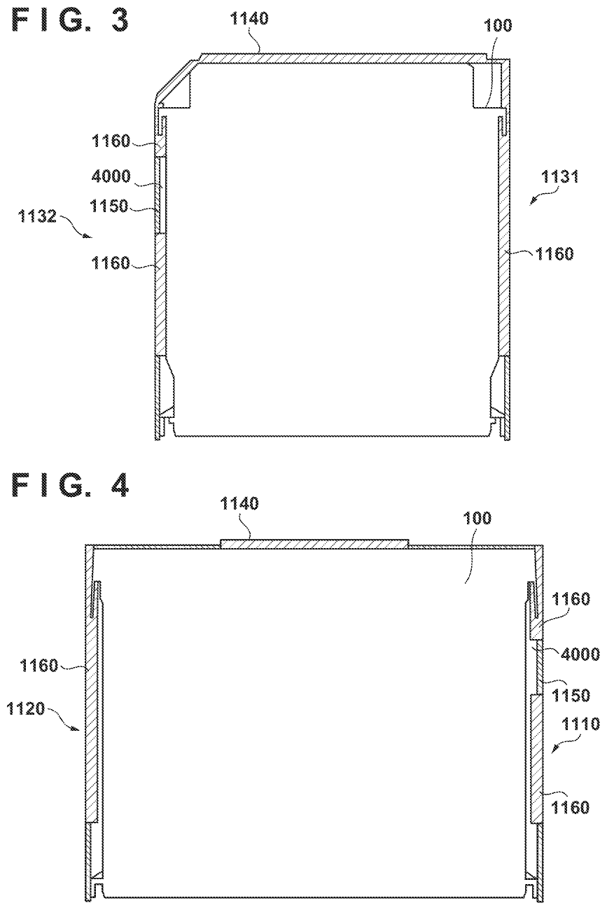

FIG. 3 is a cross-sectional view of the battery cover according to the embodiment taken along line A-A′. The side wall portion 1132 of the cover member 1100 have the ventilation portion 4000. The ventilation portion 4000 is defined by a thin portion 1150 of the side wall portion 1132 and a thick portion 1160 of the side wall portion 1132 formed thicker than the thin portion 1150. The ventilation portion 4000 directly communicates with the outlet 3000, and communicates between the inlet 2000 and the outlet 3000 to discharge the outside air 510 having been introduced from the inlet 2000 from the outlet 3000. The thick portions 1160 of the side wall portions 1131 and 1132 have a higher heat insulation property than the thin portions 1150, and thus can insulate the battery 100 from the hot air 520 from the cooling device 300 and the engine 400 to protect the battery 100 from thermal degradation.

FIG. 4 is a cross-sectional view of the battery cover according to the embodiment taken along line B-B′. The front wall portion 1110 of the cover member 1100 has the ventilation portion 4000. Similarly to the side wall portion 1132, the ventilation portion 4000 is defined by the thin portion 1150 of the front wall portion 1110 and the thick portion 1160 of the front wall portion 1110 formed thicker than the thin portion 1150. The ventilation portion 4000 communicates directly with the inlet 2000, and communicates with the outlet 3000 via the ventilation portion 4000 of the side wall portion 1132 to discharge the outside air 510 having been introduced from the inlet 2000 from the outlet 3000. The thick portion 1160 of the front wall portion 1110 also has a higher heat insulating property than the thin portion 1150, and thus can insulate the battery 100 from the hot air 520 from the cooling device 300 and the engine 400 to protect the battery 100 from thermal degradation.

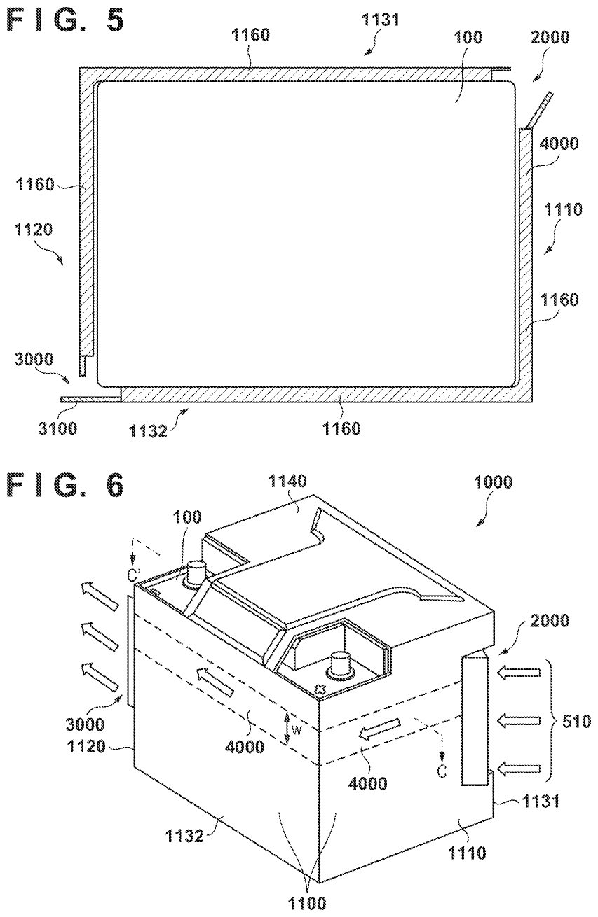

FIG. 5 is a cross-sectional view of the battery cover according to the embodiment taken along line C-C′. The front wall portion 1110 of the cover member 1100 has the inlet 2000, and the rear wall portion 1120 of the cover member 1100 has the outlet 3000. Since the C-C′ cross-sectional view illustrates a cross section of a portion not having the ventilation portion 4000, the front wall portion 1110, the rear wall portion 1120, and the side wall portions 1131 and 1132 are formed by the thick portion 1160 except for the inlet 2000 and the outlet 3000.

As illustrated in FIGS. 2 to 5, the ventilation portion 4000 is formed to discharge the outside air 510 having been introduced from the inlet 2000 from the outlet 3000, thereby efficiently cooling the battery 100. The front wall portion 1110, the rear wall portion 1120, and the side wall portions 1131 and 1132 have the thick portion 1160 with a higher heat insulating property than the thin portion 1150. Thus, these portions can insulate the battery 100 from the hot air 520 from the cooling device 300 and the engine 400 to protect the battery 100 from thermal degradation.

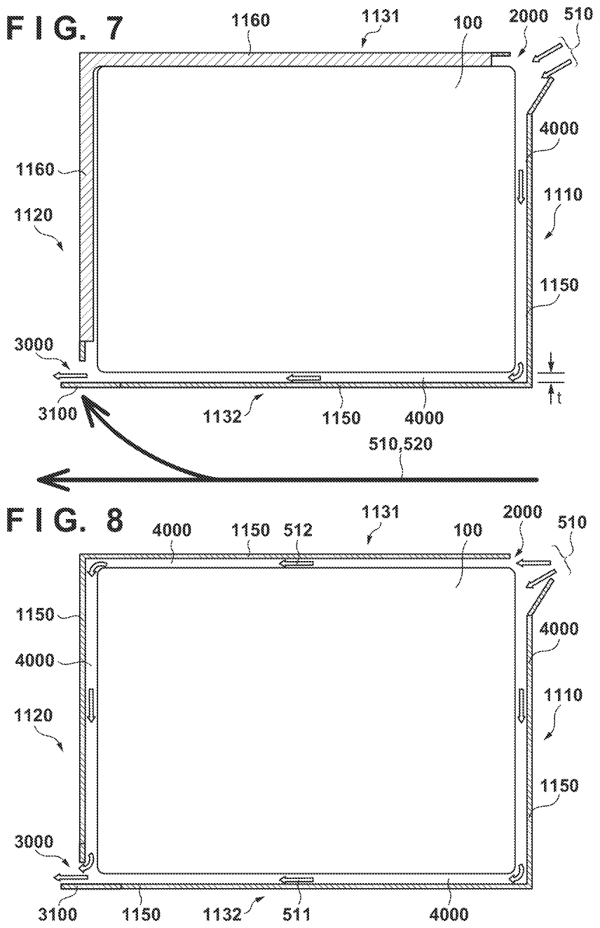

FIG. 6 is a cross-sectional view of the battery cover according to the embodiment, which illustrates a flow of outside air. FIG. 7 is a cross-sectional view of the battery cover according to the embodiment taken along line C-C′ passing through the ventilation portion. As indicated by arrows, the outside air 510 is introduced into the cover member 1100 from the inlet 2000 of the front wall portion 1110, then passes through the ventilation portion 4000 of the front wall portion 1110 and the ventilation portion 4000 of the side wall portion 1132, and then is discharged from the outlet 3000 of the rear wall portion 1120. If the battery 100 is arranged in the engine room as illustrated in FIG. 1, the outside air 510 flows from the front left side in the front-and-rear direction, and thus is more unlikely to flow toward the side wall portion 1132 than toward the side wall portion 1131. Therefore, providing the ventilation portion 4000 in the front wall portion 1110 and the side wall portion 1132 to flow the outside air 510 makes it possible to efficiently cool the battery 100.

Width w and vertical position of the ventilation portion 4000 are not particularly limited as long as the ventilation portion 4000 allows the battery 100 to be efficiently cooled by the outside air 510 and the thick portion 1160 can be provided to insulate the battery 100 from the hot air 520 from the cooling device 300 and the engine 400. Thickness t of the ventilation portion is not particularly limited as long as the ventilation portion allows the battery 100 to be efficiently cooled by the outside air 510. The dimension of the ventilation portion 4000 along the flow direction of the outside air may be referred to as length, the dimension of the ventilation portion 4000 along the up-and-down direction may be referred to as width, and the dimension of the ventilation portion 4000 along the thickness direction of the cover member may be referred to as thickness.

In the embodiment, the cover member 1100 may further include an extension member 3100 that is adjacent to the outlet 3000 and extends rearward from the outlet 3000 in the front-and-rear direction. The extension member 3100 can prevent the outside air 510 having not been introduced into the battery cover 1000 from flowing back from the outlet 3000. The arrangement of the extension member 3100 is not particularly limited, but the extension member 3100 is provided so as to shield the outlet 3000 from the hot air 520 from the engine 400. For example, the extension member 3100 may be formed so as to extend substantially parallel to the side wall portion 1132 facing the direction in which the engine 400 is located. As a result, the hot air 520 from the cooling device 300 and the engine 400 can be prevented from flowing in from the outlet 3000. In addition, the extension member 3100 may be formed to be thick or thin. Forming the extension member 3100 to be thin increases the strength of the extension member 3100 and reduces the ratio of closing the outlet 3000.

In one embodiment, the upper wall portion 1140 located on the upper side of the vehicle 200 is a lid-like member that prevents upward discharge of the outside air 510 having been introduced into the cover member 1100. Therefore, although the upper wall portion 1140 may be formed to be thin, forming the upper wall portion 1140 to be thick makes it possible to insulate the battery 100 from the hot air 520 from the cooling device 300 and the engine 400, and protect the battery 100 from thermal degradation.

### Battery Cover According to Another Embodiment

In the battery cover according to another embodiment, the ventilation portion 4000 in the battery cover 1000 illustrated in FIGS. 2 to 7 is also provided in a side wall portion 1131 and a rear wall portion 1120. Hereinafter, a ventilation portion 4000 different from the ventilation portion 4000 in the battery cover 1000 according to the embodiment will be described. The same components are denoted by the same reference numerals, and the description of the common components will be omitted.

FIG. 8 is a cross-sectional view of a battery cover according to another embodiment passing through a ventilation portion. In particular, FIG. 8 corresponds to the C-C′ cross-sectional view of the battery cover 1000 illustrated in FIG. 6 in which the ventilation portion 4000 is also provided in the side wall portion 1131 and the rear wall portion 1120. The outside air 510 is introduced into the cover member 1100 from the inlet 2000 of the front wall portion 1110 and is branched as indicated by arrows. One portion of the outside air 511 passes through the ventilation portion 4000 of the front wall portion 1110 and the ventilation portion 4000 of the side wall portion 1132 and is discharged from the outlet 3000 of the rear wall portion 1120. The other portion of the outside air 512 passes through the ventilation portion 4000 of the side wall portion 1131 and the ventilation portion 4000 of the rear wall portion 1120 and is discharged from the outlet 3000 of the rear wall portion 1120. As a result, the battery 100 can be cooled by the front wall portion 1110, the side wall portions 1131 and 1132, and the rear wall portion 1120.

### Battery Cover According to Still Another Embodiment

In a battery cover according to still another embodiment, the inlet 2000 and the outlet 3000 of the battery cover 1000 illustrated in FIG. 8 are provided substantially at the centers of a front wall portion 1110 and a rear wall portion 1120, respectively, seen along the right-and-left direction. Hereinafter, the inlet 2000, the outlet 3000, and the ventilation portion 4000 different from those of the battery cover 1000 according to another embodiment will be described. The same components are denoted by the same reference numerals, and the description of the common components will be omitted.

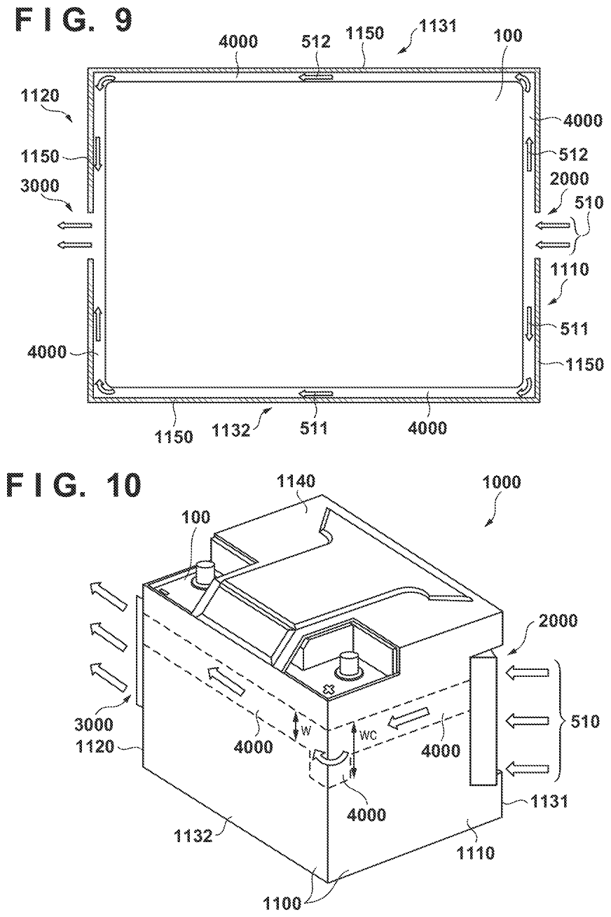

FIG. 9 is a cross-sectional view of a battery cover according to still another embodiment passing through a ventilation portion. In particular, referring to FIG. 9, in the battery cover 1000 illustrated in FIG. 6, the ventilation portion 4000 is also provided in the side wall portion 1131 and the rear wall portion 1120, and the inlet 2000 and the outlet 3000 are provided substantially at the centers of the front wall portion 1110 and the rear wall portion 1120 seen along the right-and-left direction. The outside air 510 is introduced into the cover member 1100 from the inlet 2000 of the front wall portion 1110 and is branched as indicated by arrows. One portion of the outside air 511 passes through the ventilation portion 4000 of the front wall portion 1110, the ventilation portion 4000 of the side wall portion 1132, and the ventilation portion 4000 of the rear wall portion 1120, and is discharged from the outlet 3000 of the rear wall portion 1120. The other portion of the outside air 512 passes through the ventilation portion 4000 of the front wall portion 1110, the ventilation portion 4000 of the side wall portion 1131, and the ventilation portion 4000 of the rear wall portion 1120, and is discharged from the outlet 3000 of the rear wall portion 1120. As a result, the battery 100 can be cooled by the front wall portion 1110, the side wall portions 1131 and 1132, and the rear wall portion 1120.

The positional relationship between the inlet 2000 and the outlet 3000 is not particularly limited. However, as illustrated in FIGS. 8 and 9, if the inlet 2000 and the outlet 3000 are provided on a symmetry line, lengths of ventilation portions from the inlet 2000 to the outlet 3000 are substantially equal, so that the battery 100 can be uniformly cooled.

### Battery Cover According to Still Another Embodiment

In the battery cover according to still another embodiment, the width of the ventilation portion changes in the battery cover 1000 illustrated in FIGS. 2 and 7. Hereinafter, a ventilation portion 4000 different from the ventilation portion 4000 of the battery cover 1000 according to the embodiment will be described. The same components are denoted by the same reference numerals, and description of the common components will be omitted.

FIG. 10 is a cross-sectional view of a battery cover according to still another embodiment, which illustrates a flow of outside air. Width wc (width of the vehicle along the up-and-down direction) of the ventilation portion at the corner connecting a front wall portion 1110 and a side wall portion 1132 is formed to be wider than the width w of the other ventilation portion 4000. That is, the width of the ventilation portion 4000 is wide from the front wall portion 1110 to the corner connecting the front wall portion 1110 and the side wall portion 1132, and is narrow at the ventilation portion 4000 of the side wall portion 1132 (equal to the width w of the ventilation portion 4000 of the front wall portion 1110).

As indicated by arrows, the outside air 510 is introduced into a cover member 1100 from an inlet 2000 of the front wall portion 1110, then passes through the ventilation portion 4000 of the front wall portion 1110, the ventilation portion 4000 at the corner connecting the front wall portion 1110 and the side wall portion 1132, and the ventilation portion 4000 of the side wall portion 1132, and then is discharged from the outlet 3000 of the rear wall portion 1120. As described above, since the ventilation portion at each corner is formed to be wider than the widths of the other ventilation portions, it is possible to suppress the flow of outside air from being stagnant at the ventilation portion 4000 at each corner of the cover member 1100, so that the battery 100 is more efficiently cooled.

In the battery covers according to still another embodiments illustrated in FIGS. 8 and 9, the ventilation portions 4000 can also be widened at the corner connecting the front wall portion 1110 and the side wall portion 1131 and at the corner connecting the side wall portion 1131 and the rear wall portion 1120.

### Battery Cover According to Still Another Embodiment

A battery cover according to still another embodiment further includes protrusions in the battery cover 1000 according to the above embodiment. Hereinafter, protrusions 5000 not provided in the battery covers 1000 according to the above embodiments will be described. The same components are denoted by the same reference numerals, and the description of the common components will be omitted.

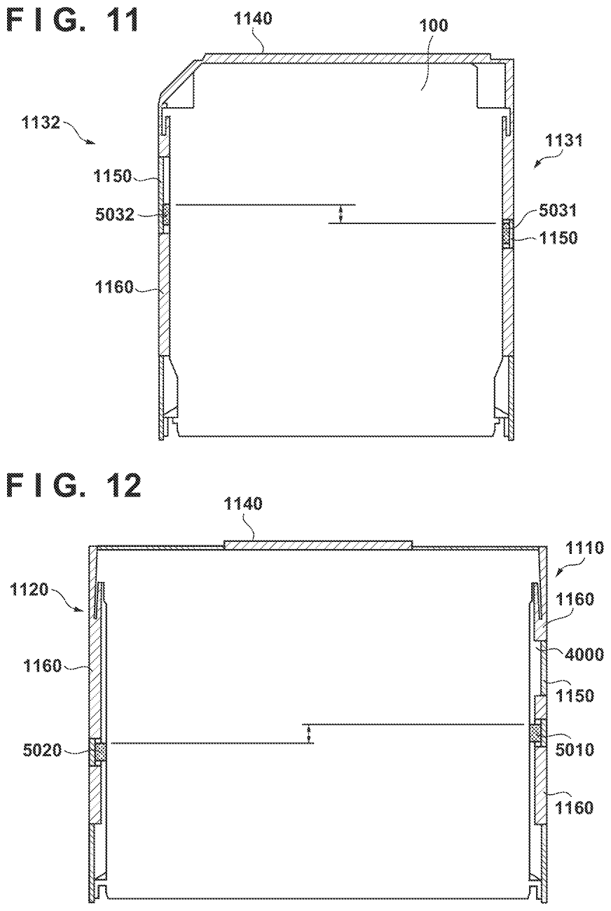

FIG. 11 is a cross-sectional view of the battery cover, which corresponds to the A-A′ cross-sectional view of the battery cover according to the embodiment illustrated in FIG. 2. FIG. 12 is a cross-sectional view of the battery cover, which corresponds to the B-B′ cross-sectional view of the battery cover according to the embodiment illustrated in FIG. 2. A front wall portion 1110, a rear wall portion 1120, and side wall portions 1131 and 1132 of a cover member 1100 internally have protrusions 5010, 5020, 5031, and 5032 at a place facing a battery 100. Hereinafter, the protrusions 5010, 5020, 5031, and 5032 will also be collectively referred to as “protrusions 5000”.

The protrusions 5010, 5020, 5031, and 5032 are arranged at different positions in the up-and-down direction of the vehicle. Since the protrusions 5000 are arranged as described above, at attachment of the battery cover 1000 to the battery 100, the portions of the battery cover 1000 come into contact with or become caught in the battery 100 at different timings (in sequence). Thus, the battery cover 1000 can be easily attached to the battery 100. Similarly, at the removal of the battery cover 1000 from the battery 100, the portions of the battery cover 1000 come into contact with or become caught in the battery 100 at different timings (in sequence). Thus, the battery cover 1000 can be easily removed from the battery 100.

The protrusions 5000 may be formed on at least some of the front wall portion 1110, the rear wall portion 1120, the side wall portion 1131, and the side wall portion 1132. The protrusions 5000 can be provided on the front wall portion 1110 and the rear wall portion 1120 or on the rear wall portion 1120 and the side wall portion 1131, which are opposing wall portions of the cover member 1100. In this manner, arranging the protrusions 5000 on the opposing wall portions provides a uniform gap between the battery cover 1000 and the battery 100. Accordingly, one opposing wall portion of the battery cover 1000 is not pressed against the battery 100 with respect to the other wall portion, which allows the outside air to easily flow.

The protrusions 5000 are provided inside the front wall portion 1110, the rear wall portion 1120, and the side wall portions 1131 and 1132, and the means for attaching or fixing the protrusions 5000 is not limited. The protrusions 5000 are to be in contact with the battery 100, and can have stretchability and/or heat insulating property.

### Battery Cover Assembly According to One Embodiment

A battery cover assembly according to an embodiment further includes a battery arrangement part in the battery cover 1000 illustrated in FIGS. 2 and 6. Hereinafter, the battery arrangement part 7000 will be described. The same components are denoted by the same reference numerals, and the description of the common components will be omitted.

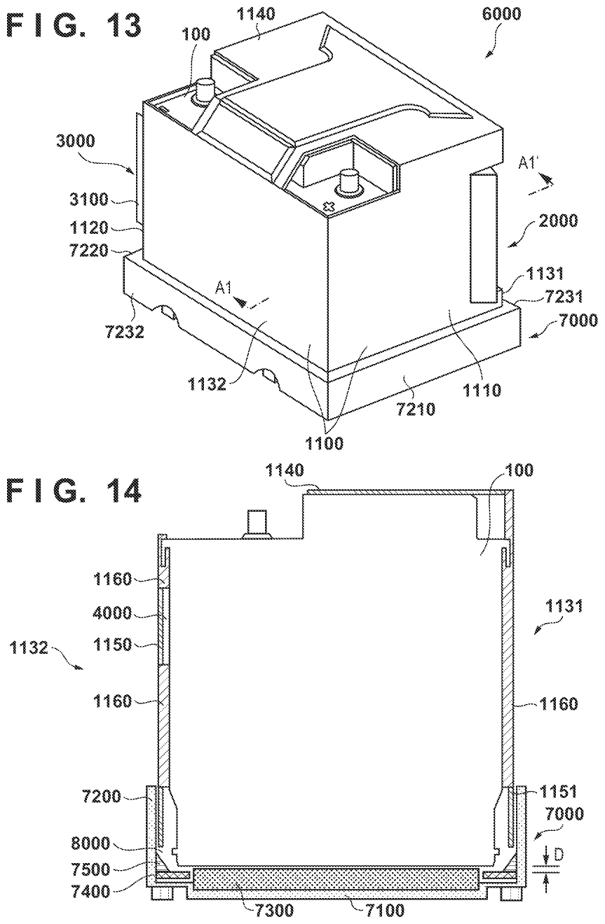

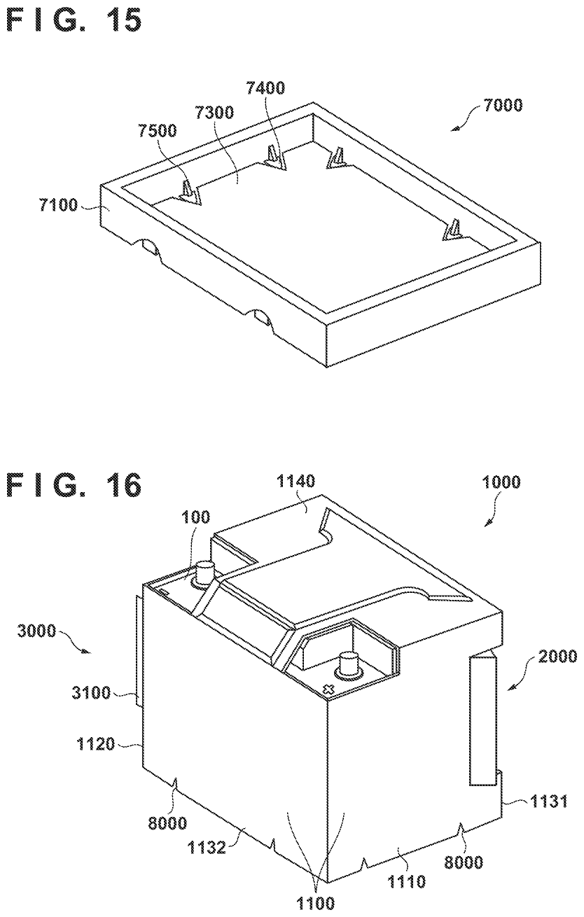

FIG. 13 is a schematic view of the battery cover assembly according to the embodiment. FIG. 14 is a cross-sectional view of a battery cover of the battery cover assembly according to the embodiment taken along line A1-A1′; FIG. 15 is a schematic view of a battery arrangement part according to the embodiment. As illustrated in FIG. 13, a battery cover assembly 6000 further includes a battery arrangement part 7000 below a battery cover 1000 in the up-and-down direction. As illustrated in FIGS. 13 and 14, the battery arrangement part 7000 includes a bottom portion 7100 on which the battery 100 is placed, and wall portions 7210, 7220, 7231, and 7232 (hereinafter, also collectively referred to as “wall portions 7200”) that surround a part of the cover member 1100 and extend from the bottom portion 7100. As illustrated in FIG. 15, the battery arrangement part 7000 is a container member that holds the battery 100.

A portion 1151 of the cover member 1100 surrounded by the wall portions 7200 can be formed to be thicker than the thin portion 1150 or can be formed to be thin equivalent to the thin portion 1150. Forming the portion 1151 of the cover member 1100 surrounded by the wall portions 7200 to be thin equivalent to the thin portion 1150 allows the battery cover 1000 to be easily inserted between the battery 100 and the battery arrangement part 7000, and the rigidity is higher than that in a case where the portion 1151 is formed to be thick. In addition, in the case of forming the portion 1151 of the cover member 1100 surrounded by the wall portion 7200 so as to be thicker than the thin portion 1150, a core material that is hardly bent may be added to the inside of the portion 1151 to supplement the rigidity.

Furthermore, insulators (heat resistant materials) can be installed on the outer surfaces of the wall portions 7200 to improve the heat insulation property. In particular, in order to insulate the battery from the hot air 520 from the cooling device 300 and the engine 400, insulators (heat resistant members) may be installed on outer side surfaces of the wall portions 7210 and 7232 facing the cooling device 300 and the engine 400.

As illustrated in FIGS. 14 and 15, the battery arrangement part 7000 includes a heat insulation arrangement portion 7300 and support portions 7400. The heat insulation arrangement portion 7300 is provided on the bottom portion 7100 to support the battery 100, and have a heat insulation property. The heat insulation arrangement portion 7300 can improve the heat insulating property on the lower side in the up-and-down direction. The support portions 7400 are provided on the wall portions 7200, and the heat insulation arrangement portion 7300 has notches corresponding to the support portions 7400. Thus, the heat insulation arrangement portion 7300 can be easily positioned by the support portions 7400 with respect to the battery arrangement part 7000.

The battery arrangement part 7000 also includes fitting portions 7500. The fitting portions 7500 are provided on the support portions 7400 at the wall portions 7200. As described above, since the fitting portions 7500 are provided at the wall portions 7200, the position of the battery arrangement part 7000 is stabilized as compared with a case where the fitting portions 7500 are provided at another member that may be changed in position, for example, the heat insulation arrangement portion 7300 or the like.

On the other hand, FIG. 16 is a schematic view of the battery cover of the battery cover assembly according to the embodiment, in which the battery arrangement part 7000 is not illustrated in the battery cover assembly according to the embodiment illustrated in FIG. 13. The cover member 1100 includes notch portions 8000 on the lower side seen along the up-and-down direction. As illustrated in FIG. 14, the notch portions 8000 are formed at positions corresponding to the fitting portions 7500 of the battery arrangement part 7000. The notch portions 8000 are fitted to the fitting portions 7500. This allows the cover member 1100 to be easily attached to and detached from the battery arrangement part 7000 in the up-and-down direction. Furthermore, since the cover member 1100 is less likely to shift in the front-and-rear direction and/or the right-and-left direction with respect to the battery arrangement part 7000, the positions of the inlet 2000 and the outlet 3000 can be fixed, and the variation in cooling performance of the battery cover 1000 with respect to the battery 100 can be reduced.

### Battery Cover Assembly According to Another Embodiment

A battery cover assembly according to another embodiment further includes a fixing member in the battery cover assembly 6000 illustrated in FIG. 13. Hereinafter, the fixing member 9000 different from the battery cover assembly 6000 according to the embodiment will be described. The same components are denoted by the same reference numerals, and the description of the common components will be omitted.

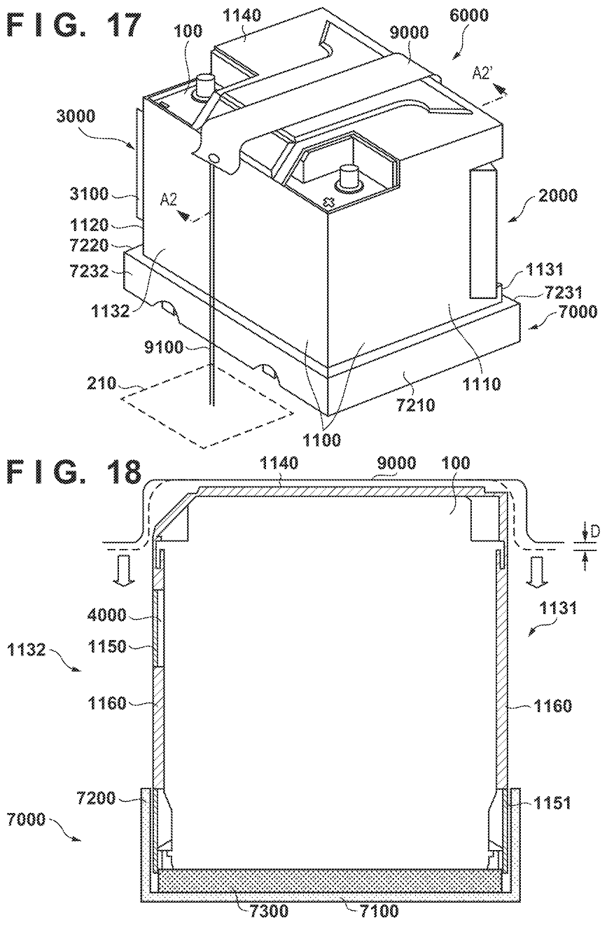

FIG. 17 is a schematic diagram of a battery cover assembly according to another embodiment. FIG. 18 is a cross-sectional view of a battery cover of the battery cover assembly according to another embodiment illustrated in FIG. 17 taken along line A2-A2′. As illustrated in FIG. 17, the battery cover assembly 6000 further includes a fixing member 9000 on the upper side seen along the up-and-down direction. The fixing member 9000 can fasten and fix a battery 100 and a battery cover 1000 to a part 210 of a vehicle 200 by a bar-shaped member 9100 such as a bolt. In addition, as illustrated in FIGS. 17 and 18, the fixing member 9000 can have its sides deformed (bent) as indicated by dotted lines in the arrow direction by being fixed by the bar-shaped member 9100. The fixing member 9000 can deform and has a deformable amount D. FIG. 18 does not illustrate the bar-shaped member 9100.

On the other hand, as illustrated in FIG. 14, the battery arrangement part 7000 includes the heat insulation arrangement portion 7300 and the support portion 7400. The upper portion (upper surface) of the support portion 7400 is positioned closer to the bottom portion 7100 than the upper portion (upper surface) of the heat insulation arrangement portion 7300 by the deformable amount D of the fixing member 9000. Even if the battery 100 and the battery cover 1000 are fixed by the fixing member 9000 and the battery 100 moves downward in the up-and-down direction due to deformation, compression, or the like of the heat insulation arrangement portion 7300 over time, the amount of movement is the distance between the upper portions of the support portions 7400 and the upper portion of the heat insulation arrangement portion 7300, that is, the maximum deformable amount D. Therefore, the battery 100 is supported by the support portions 7400, and the battery 100 is suppressed from being loosened by the fixing member 9000.

### Summary of Embodiments

The above embodiments disclose at least the following battery cover and battery cover assembly.

1. A battery cover (1000) according to the above embodiment comprises:
a cover member (1100) that has a heat insulating property and encloses a battery (100) mounted on a vehicle (200);
an inlet (2000) formed in the cover member (1100) to introduce outside air (510) into the cover member (1100) of the vehicle (200); and
an outlet (3000) formed in the cover member (1100) to discharge the outside air (510) introduced into the cover member (1100) from the inlet (2000), wherein
the cover member (1100) includes a ventilation portion (4000) that connects the inlet (2000) and the outlet (3000), and the ventilation portion (4000) is defined by a thin portion (1150) of the cover member (1100) and a thick portion (1160) of the cover member (1100) formed thicker than the thin portion (1150).

According to the embodiments, the battery can be efficiently cooled by discharging the outside air having flowed into the battery cover through the ventilation portions, and the battery can be efficiently protected from the ambient temperature environment.

2. In the above embodiment, the thick portion (1160) has a higher heat insulating property than the thin portion (1150).

According to the embodiments, the battery can be insulated from hot air from the cooling device and the engine and can be protected from thermal degradation.

3. In the above embodiment, the cover member (1100) includes a front wall portion (1110) located on a front side of the vehicle (200), a rear wall portion (1120) located on a rear side of the vehicle (200), and left and right side wall portions (1131, 1132) located between the front wall portion (1110) and the rear wall portion (1120).

According to the embodiments, the battery can be efficiently protected from the ambient temperature environment.

4. In the above embodiment, a width of the ventilation portion (4000) of the vehicle (200) seen along the up-and-down direction at a corner connecting the front wall portion (1110) and the rear wall portion (1120) and the side wall portions (1131, 1132) is made larger than a width of another ventilation portion (4000) seen along the up-and-down direction of the vehicle (200).

According to the embodiments, the flow of outside air is suppressed from being stagnant at the ventilation portions at the corners of the cover member, whereby the battery is more efficiently cooled.

5. The above embodiment further comprises an extension member (3100) extending from the outlet (3000) in a rear direction of the vehicle (200).

According to the embodiments, it is possible to prevent the outside air from flowing backward from the outlet.

6. In the above embodiment, the extension member (3100) is provided to shield the outlet (3000) from an engine (400) of the vehicle (200).

According to the embodiments, hot air from the cooling device and the engine can be prevented from flowing in from the outlet.

7. The above embodiment further comprises a plurality of protrusions (5000) at a place facing the battery (100) in the cover member (1100),
the protrusions (5000) are arranged at different positions in the up-and-down direction of the vehicle (200).

According to the embodiments, it is easy to attach and detach the battery cover to and from the battery.

8. In the above embodiment, the protrusions (5000) are provided on opposing wall portions in the cover member (1100).

According to the embodiments, it is possible to provide a uniform gap between the battery cover and the battery. Accordingly, one opposing wall portion of the battery cover is not pressed against the battery with respect to the other wall portion, which allows the outside air to easily flow.

9. A battery cover assembly (6000) comprises:
the battery cover according to the above embodiment; and
a battery arrangement part (7000),
the battery arrangement part (7000) includes a bottom portion (7100) on which the battery is placed and a wall portion (7200) surrounding a portion of the cover member (1110) and extending from the bottom portion (7100), and
the portion of the cover member (1110) surrounded by the wall portion (7200) is made thin so as to be equivalent to the thin portion (1150).

According to the embodiments, the battery cover can be easily inserted between the battery and the battery arrangement part, which makes the rigidity higher than that in a case where the corresponding portion of the cover member is formed thick.

10. The above embodiment further comprises a fixing member (9000) that fixes the battery (100) to the vehicle (200),
the battery arrangement part (7000) includes a heat insulation arrangement portion (7300) that is provided on the bottom portion (7100) and has a heat insulation property, and a support portion (7400) that is provided on the wall portion (7200) so as to position the heat insulation arrangement portion (7300), and
an upper portion of the support portion (7400) is positioned closer to the bottom portion (7100) than an upper portion of the heat insulation arrangement portion (7300) by a deformable amount of the fixing member (9000).

According to the embodiments, the heat insulating property is improved by the heat insulation arrangement portion, and the heat insulation arrangement portion can be easily positioned by the support portion with respect to the battery arrangement part. Furthermore, it is possible to suppress the fixation of the battery by the fixing member from being loosened.

11. In the above embodiment,
the battery arrangement part (7000) includes a fitting portion (5500), and
the portion of the cover member (1100) surrounded by the wall portion (7200) has a notch portion (8000) at a position corresponding to the fitting portion (5500).

According to this embodiment, the cover member can be easily attached and detached in the up-and-down direction to and from the heat insulation arrangement portion, and the cover member is unlikely to shift in the front-and-rear direction and/or the right-and-left direction with respect to the heat insulation arrangement portion. Therefore, the positions of the inlet and outlet can be fixed, and the variation in cooling performance of the battery cover with respect to the battery can be reduced. Further, since the fitting portions are provided on the wall portions 7200, the positions of the fitting portions are more stable than the positions of the fitting portions provided on the movable heat insulation arrangement portion.

The invention is not limited to the foregoing embodiments, and various variations/changes are possible within the spirit of the invention.

What is claimed is:

1. A battery cover comprising:
a cover member that has a heat insulating property and encloses a battery mounted on a vehicle;
an inlet formed in the cover member to introduce outside air into the cover member of the vehicle; and
an outlet formed in the cover member to discharge the outside air introduced into the cover member from the inlet, wherein
the cover member includes a ventilation portion that connects the inlet and the outlet, and the ventilation portion is defined by a thin portion of the cover member and a thick portion of the cover member formed thicker than the thin portion.

2. The battery cover according to claim 1, wherein the thick portion has a higher heat insulating property than the thin portion.

3. The battery cover according to claim 1, wherein the cover member includes a front wall portion located on a front side of the vehicle, a rear wall portion located on a rear side of the vehicle, and left and right side wall portions located between the front wall portion and the rear wall portion.

4. The battery cover according to claim 3, wherein a width of the ventilation portion of the vehicle seen along the up-and-down direction at a corner connecting the front wall portion and the rear wall portion and the side wall portions is made larger than a width of another ventilation portion seen along the up-and-down direction of the vehicle.

5. The battery cover according to claim 1, further comprising an extension member extending from the outlet in a rear direction of the vehicle.

6. The battery cover according to claim 5, wherein the extension member is provided to shield the outlet from an engine of the vehicle.

7. The battery cover according to claim 1, further comprising a plurality of protrusions at a place facing the battery in the cover member, wherein
the protrusions are arranged at different positions in the up-and-down direction of the vehicle.

8. The battery cover according to claim 7, wherein the protrusions are provided on opposing wall portions in the cover member.

9. A battery cover assembly comprising:
the battery cover according to claim 1; and
a battery arrangement part, wherein
the battery arrangement part includes a bottom portion on which the battery is placed and a wall portion surrounding a portion of the cover member and extending from the bottom portion, and
the portion of the cover member surrounded by the wall portion is made thin so as to be equivalent to the thin portion.

10. The battery cover assembly according to claim 9, further comprising
a fixing member that fixes the battery to the vehicle, wherein
the battery arrangement part includes a heat insulation arrangement portion that is provided on the bottom portion and has a heat insulation property, and a support portion that is provided on the wall portion so as to position the heat insulation arrangement portion, and
an upper portion of the support portion is positioned closer to the bottom portion than an upper portion of the heat insulation arrangement portion by a deformable amount of the fixing member.

11. The battery cover assembly according to claim 9, wherein
the battery arrangement part includes a fitting portion, and
the portion of the cover member surrounded by the wall portion has a notch portion at a position corresponding to the fitting portion.
